(19) United States
(12) Patent Application Publication
(10) Pub. No.: US 2005/0154087 A1
(43) Pub. Date: Jul. 14, 2005

(54) Composite material and method of manufacturing the same

(75) Inventor: Hiroshi Kobayashi, Kariya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/998,008

(22) Filed: Nov. 29, 2004

(30) Foreign Application Priority Data
Nov. 28, 2003 (JP) 2003-400063
Mar. 25, 2004 (JP) 2004-089942

(51) Int. Cl. C08K 3/40

(52) U.S. Cl. 523/219; 524/494

(57) ABSTRACT

A composite material includes a thermoplastic resin, and silica glass spheres having a specific surface area of 0.5-10 m²/g. The composite material incorporates the silica glass spheres in an amount of 40% by volume or more. A method of manufacturing a composite material incorporating a thermoplastic resin and silica glass spheres manufactures the composite material which incorporates the silica glass spheres at a compounding ratio determined on a basis of a coefficient of linear expansion of the composite material at a singular point of the thermoplastic resin.

### CROSS REFERENCE TO RELATED APPLICATIONS

This application is based on and claims priority under 35 U.S.C. §119 with respect to Japanese Patent Application 2004-089942, filed on Mar. 25, 2004, the entire content of which is incorporated herein by reference.

### FIELD OF THE INVENTION

This invention generally relates to a composite material having incorporated therein a thermoplastic resin and silica, and to a method of manufacturing the same.

### BACKGROUND

Studies in recent years have led to improvements in the attributes of a thermoplastic resin, which are secured by means of compounding glass filler in a thermoplastic resin.

Japanese patent No. 2856793 discloses a composite material, on which a glass and an organic polymer compound disperse uniformly and finely. In this composite material, attributes, which are originally ascribed to respective constituent elements contained in the composite material, can be improved. Examples of the attributes that are improved are insufficient mechanical strength, slipperiness and an attribute of becoming easily worn out.

Japanese patent application publication No. 09(1997)-157509 discloses a polycarbonate resin composition having incorporated therein a polycarbonate resin blended with inorganic filler such as glass beads. This composition is superior in terms of surface smoothness.

Japanese patent application publication No. 09(1997)-151298 discloses a polyacetal resin composition having incorporated therein a polyacetal resin blended with a glass-type inorganic filler and a boric acid compound. This polyacetal resin composition is superior in terms of mechanical strength.

U.S. Pat. No. 5,633,080 discloses a polyester film having incorporated therein polyester blended with a combination of glass spheres and calcined clay. This polyester film excels in terms of handleability, while also maintaining good optical clarity and transparency.

In terms of a large coefficient of linear expansion as an attribute of a thermoplastic resin, U.S. Pat. No. 4,703,074 discloses a method of compounding a material such as silicic acid or a silicate in a polyphenylene sulfide resin.

As described above, in order to improve the attributes of a thermoplastic resin that can be applied for various uses, studies have been carried on on technologies for compounding various types of glass fillers in a thermoplastic resin.

As for reducing the coefficient of linear expansion of the thermoplastic resin, in the aforementioned related art for combining filler such as silicic acid or a silicate in the polyphenylene sulfide resin, a coefficient of linear expansion of a composite material containing the polyphenylene sulfide resin and such filler therein can be reduced by combining a considerable volume of such filler in the polyphenylene sulfide resin. However, a polyphenylene sulfide resin that can be applied is limited to a low molecular weight polyphenylene sulfide resin of which melt index is 1000 g/min. or more. Therefore, composite materials with a polyphenylene sulfide resin and such filler have so far been inferior in properties such as heat resistance, chemical resistance and mechanical strength.

On the other hand, when a thermoplastic resin other than the polyphenylene sulfide resin is combined with filler such as silicic acid or a silicate, because of the high degree of viscosity of the thermoplastic resin, a sufficient volume of filler cannot be combined in the thermoplastic resin. Hence, a composite material with a conventional thermoplastic resin has not been capable of achieving a target coefficient of linear expansion. Further, even when it has been possible to combine a predetermined volume of filler in the thermoplastic resin, the act of combining the filler therein has resulted in an increase of the viscosity of the composite material, thereby causing a deterioration of the moldability an inferior moldability of the composite material.

The present invention has been made in view of the above circumstances, and provides such a composite material, and a method of manufacturing the same.

### SUMMARY OF THE INVENTION

According to an aspect of the present invention, a composite material includes a thermoplastic resin, and silica glass spheres having a specific surface area of 0.5-10 m²/g. The composite material incorporates the silica glass spheres in an amount of 40% by volume or more.

According to another aspect of the present invention, a composite material includes a thermoplastic resin, and silica glass spheres mixed with plural types of silica glass spheres of which peaks of frequency in terms of particle size distribution are different.

According to still another aspect of the present invention, a method of manufacturing a composite material incorporating a thermoplastic resin and silica glass spheres manufactures the composite material which incorporates the silica glass spheres at a compounding ratio determined on a basis of a coefficient of linear expansion of the composite material at a singular point of the thermoplastic resin.

### BRIEF DESCRIPTION OF THE DRAWINGS

The foregoing and additional features and characteristics of the present invention will become more apparent from the following detailed description considered with reference to the accompanying drawings, wherein:

FIG. 1 is a photograph illustrating a composite material having incorporated therein a polyphenylene sulfide (PPS) resin and silica glass spheres according to an embodiment of the present invention;

FIG. 2 is a drawing for explaining a principle for improving mechanical strength of the composite material;

FIG. 3 is a diagram of aluminum particle size distribution;

FIG. 4 is another diagram of the aluminum particle size distribution;

FIG. 5 is a diagram for explaining a heat analysis data of the aluminum particles;

FIG. 6 is another diagram for explaining the heat analysis data of the aluminum particles;

FIG. 7 is a photograph of silica glass spheres manufactured by a fusion method;

FIG. 8 is another photograph of the silica glass spheres manufactured by the fusion method;

FIG. 9 is a photograph of aluminum particles manufactured by an atomizing method;

FIG. 10 is a drawing illustrating a solenoid valve;

FIG. 11 is a diagram for explaining a silica glass sphere particle size distribution;

FIG. 12 is a diagram for explaining a coefficient of linear expansion of the composite material according to the embodiment of the present invention;

FIG. 13 is a diagram for explaining a relationship between a coefficient of linear expansion of a thermoplastic resin and a compounding ratio of filler;

FIG. 14 is a diagram for explaining the coefficient of linear expansion of the composite material according to the embodiment of the present invention;

FIG. 15 is a photograph of a tip end of a valve;

FIG. 16 is another photograph of the tip end of the valve; and

FIG. 17 is still another photograph of the tip end of the valve.

### DETAILED DESCRIMON

An embodiment of the present invention will be described in detail below with reference to the accompanying drawings.

A composite material according to the embodiment of the present invention is incorporated at least with a thermoplastic resin as a matrix and silica (SiO₂) as a reinforcement material and can be manufactured by a method described below. Therefore, it is possible for this composite material to have a smaller coefficient of linear expansion than that of a conventional thermoplastic resin such as PPS, polybutylene terephthalate (PBT) and nylon.

The inventor of the present invention has verified that the coefficient of linear expansion of a thermoplastic resin composite material having a thermoplastic resin blended in an arbitrary volume ratio with filler, of which a coefficient of linear expansion is smaller than that of the thermoplastic resin, can be controlled regardless of the type of thermoplastic resin.

Preferable filler for the thermoplastic resin composite material is silica, of which a coefficient of linear expansion is smaller than that of a commonly used thermoplastic resin, and which has stable thermal and chemical attributes. Moreover, silica glass with an amorphous structure, which has a good handleability and a good safety, being different from crystalline silica, is preferable. Specifically, among commonly used glasses, a coefficient of linear expansion of silica glass is 0.55×10⁻⁶/° C., that of flint glass is 0.91×10⁻⁵/° C., that of soda-lime glass is 1.0×10⁻⁵/° C. that of Pyrex glass is 0.36×10⁻⁵/° C. and that of borosilicate glass is 0.55×10⁻⁵/° C. The silica glass has a smaller coefficient of linear expansion than the other glasses. Therefore, a thermoplastic resin composite material blended with such silica glass in a determined volume ratio relative to a volume of the thermoplastic resin can have a smaller coefficient of linear expansion than that of other thermoplastic resin composite material blended with other glasses in the same volume ratio. Accordingly, by combining the silica glass in the thermoplastic resin composite material at an arbitrary volume ratio, the coefficient of linear expansion of the composite material can be controlled within a considerable range.

In conventional thermoplastic resin composite materials, when glass filler is combined in a thermoplastic resin, a fiber type glass has been applied as the glass filler. The fiber type glass filler is oriented along a resin flowing direction of the thermoplastic resin. In such circumstance, the coefficient of linear expansion of such molten resin in a direction at right angles to the resin flowing direction is greater than that in the resin flowing direction. Further, a difference between the coefficient of linear expansion in the direction at right angles to the resin flowing direction and that in the resin flowing direction becomes more pronounced. For the purpose of reducing the difference in the coefficient of linear expansion, it is preferable that the glass filler be substantially sphere-shaped. In other words, in order to reduce the coefficient of linear expansion of the composite material, and in order to reduce the difference in the coefficient of linear expansion, it is preferable that the thermoplastic resin composite material according to the embodiment of the present invention be blended with substantially sphere-shaped silica glass particles (hereinafter, referred to as silica glass spheres).

As described above, by combining such silica glass spheres in the thermoplastic resin, the coefficient of linear expansion of the thermoplastic resin combined with such silica glass spheres can be effectively reduced in comparison with the coefficient of linear expansion of the thermoplastic resin that has not been combined therewith. The compounding volume ratio of the silica glass spheres in the thermoplastic resin is not limited to one compounding volume ratio, but can rather be decided on a basis of a coefficient of linear expansion required for various usages of the composite material. In particular, regardless of the type of thermoplastic resin, by blending the silica glass spheres in a volume of 40 vol. % or more relative to the volume of the thermoplastic resin composite material, the thermoplastic resin composite material can obtain a coefficient of linear expansion lower than that of a composite material in which another type of filler has been blended. In order to reduce further the coefficient of linear expansion of this thermoplastic resin composite material, it is preferable that the silica glass spheres are combined in a volume of 50 vol. % or more relative to the thermoplastic resin composite material.

In general, when fiber-type glass filler is blended in the thermoplastic resin, because of the compounding volume ratio relative to the thermoplastic resin, the fiber-type glass filler may intertwine easily. In other words, it may become difficult to compound uniformly such fiber-type glass filler in 40 vol. % or more in the thermoplastic resin composite material. In particular, when the thermoplastic resin composite material with this amount of glass filler is molded, a melting viscosity thereof becomes too thick to be utilized for practical purposes.

In light of the foregoing, the inventor of the present invention has focused attention on a specific surface area (surface area per unit volume which is used to determine the particle size) and on a particle size of the silica glass spheres and examined carefully the thermoplastic resin composite material. As a result, the inventor has proved that such silica glass spheres as the filler can disperse uniformly in the thermoplastic resin, and that the melting viscosity of the composite material will not go up even when the silica glass spheres of 40 vol. % or more are blended as the glass filler in the thermoplastic resin. Moreover, it has become possible for the coefficient of linear expansion of the thermoplastic resin to be even further reduced.

As verified above, it is preferable that a bulk density of the silica glass spheres be reduced for purposes of blending a greater quantity of silica glass spheres in the thermoplastic resin. If the silica glass spheres occupy a specific surface area of 0.5-10 m²/g, the thermoplastic resin composite material can incorporate the silica glass spheres at 40 vol. % or more of the volume of the composite material. Moreover, a particle size of the silica glass spheres can be selected arbitrarily in accordance with the various types of products to be manufactured.

Further more, by combining in the thermoplastic resin a mixture of plural silica glass spheres, of which peaks of frequency vary in the area of particle size distribution, the bulk density of the silica glass spheres can be preferably controlled at a low level, thereby resulting in an increase of the compounding volume ratio of the silica glass spheres in the thermoplastic resin composite material. In particular, it is preferable that the thermoplastic resin composition material incorporates a mixture of at least three types of silica glass spheres: large particle-size silica glass spheres, of which a peak of frequency is confined within a range of a relatively large particle size in terms of particle size distribution, middle particle-size silica glass spheres, of which a peak of frequency is confined within a range of a relatively middle particle size in terms of particle size distribution and small particle-size silica glass spheres, of which a peak of frequency is confined within a range of a relatively small particle size. As a generality, when silica glass spheres of varying particle sizes are combined therein, the bulk density of the silica glass spheres is greater in a thermoplastic resin composite material incorporating only large particle-size silica glass spheres, while a melting density thereof is higher in the thermoplastic resin composite material incorporating only small particle-size silica glass spheres. It thus becomes possible to combine in a compounding volume ratio, which has not been feasible when a single type of silica glass spheres had been combined, plural types of silica glass spheres in the composite material.

It is also preferable that the silica glass sphere particle size distribution consists of three peaks of frequency respectively confined within appropriate ranges. For example, it is preferable that, in terms of silica glass sphere size distribution, the peak of frequency of large particle-size silica glass spheres be confined within a range of 20-60 μm, the peak of frequency of middle particle-size silica glass spheres be confined within a range of 5-20 μm and the peak of frequency of small particle-size silica glass spheres be confined within a range of 1-3 μm. It is further preferable that the volume ratio of the large particle-size silica glass spheres and the middle particle-size silica glass spheres be 70 vol. % or more (more preferably, 70-90 vol. %) relative to the total volume of the silica particle spheres combined in the thermoplastic resin composite material, thereby ensuring effective blending of the silica glass spheres in the thermoplastic resin composite material. For example, when a mixture of large particle-size silica glass spheres, middle particle-size silica glass spheres and small particle-size silica glass spheres, mixed in a compounding ratio, which decreases in a descending order such as a weight ratio of 4:3:1, is compounded in the thermoplastic resin, the silica glass spheres can be effectively blended and a high level of filling performance is achieved.

A thermoplastic resin having silica glass spheres mixed therein is not limited to a certain type of thermoplastic resin, and various resins such as polysulfide resin, polyester resin, polyamide resin and polycarbonate resin can be applied, depending on the use. In particular, from the viewpoint of heat resistance, moldability and chemical stableness, a resin such as a polyphenylene sulfide (PPS) resin, a polybutylene terephthalate (PB) resin and a nylon resin is preferably applied. Of course, a thermoplastic resin composite material does not need to incorporate a single type of thermoplastic resin, but can also incorporate a copolymer resin consisting of two or more different resin monomers, or a mixture thereof.

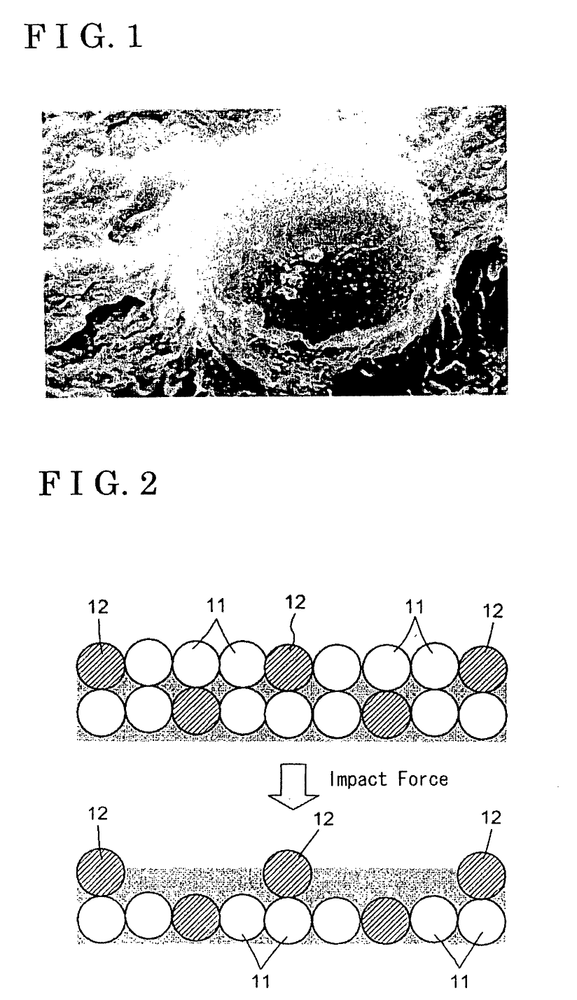

As described above, the composite material according to the embodiment of the present invention is manufactured by compositing the silica glass spheres as a reinforcement material in the thermoplastic resin as a matrix. For purposes of enhancing affinity between the thermoplastic resin and the silica glass spheres, it is preferable that the silica glass spheres be bonded with the thermoplastic resin by use of a coupling agent. Moreover, bonding of the thermoplastic resin and the silica glass spheres results in an attribute of the thermoplastic resin composite material which is somewhat different from that of a substance produced by a process of merely mixing the thermoplastic resin and the silica glass spheres. It thus becomes possible to reduce the coefficient of linear expansion of a composite material produced by mutual interactions. The coupling agent is not limited to a single type of agent but can be a coupling agent having a functional group that bonds with the thermoplastic resin and a functional group that bonds with the silica glass spheres, a coupling agent capable of improving wettability of the thermoplastic resin, or the like. Although conventional coupling agents can be applied, a coupling agent with an epoxy group is preferable in the case of a thermoplastic resin having a carboxyl group, while a coupling agent with an amide group is preferable in the case of the nylon resin or PBT resin. For the silica glass spheres, a coupling agent with a functional group of Si—(OR)₃ (R: alkyl group) is preferable. Moreover, even when the thermoplastic resin does not respond directly to the coupling agent applied, affinity between the thermoplastic resin and the silica glass spheres can be enhanced by improving the wettability of the thermoplastic resin. For example, when a PPS resin and the silica glass spheres are blended by use of a coupling agent of which the molecular formula is (CH₂OH)CH₂OC₃H₆Si(OCH₃)₃, as illustrated in FIG. 1, the PPS resin and the silica glass spheres can be blended and unified with a satisfactory level of affinity therebetween.

On the other hand, the silica glass sphere combined in the thermoplastic resin composite material according to the embodiment of the present invention also has one of its attributes as a high degree of hardness. Therefore, an external impact force, which might be applied to this composite material, would not be easily absorbed by the silica glass spheres but would be transmitted to boundary surfaces between the thermoplastic resin and the silica glass spheres. As described above, the thermoplastic resin and the silica glass spheres are mixed uniformly in the composite material and the composite material accordingly possesses a high cohesive strength. However, once an impact force, which is greater than the cohesive strength between the thermoplastic resin and the silica glass spheres, is applied to the composite material, on occasions strains may occur at the boundary surfaces. Further, when an impulse force is applied to the composite material repeatedly, the boundary surfaces may collapse, and furthermore, it is conceivable that silica glass spheres positioned at a surface of the composite material may drop off. Still further, the impact force may wear out a thermoplastic resin positioned at a surface of the composite material and expose the silica glass spheres inside the composite material. In this case, there is also a fear that the silica glass spheres might also drop off in response to repeated wear-out of the thermoplastic resin, thereby eventually causing the composite material to collapse.

As described above, for a composite material for a use requiring a crushproof, it is possible that the composite material according to the embodiment of the present invention is added with a metal particle. Namely, by blending a mixture of silica glass spheres and metal particles in a thermoplastic resin, a composite material incorporating the mixture of silica glass spheres and metal particles and the thermoplastic resin can possess highly improved mechanical strength as one of attributes, while a coefficient of linear expansion thereof can be controlled at a low level. Attributes of a metal particle such as malleability and ductility enables the metal particle to absorb an impact force in response to deformation thereof. In this case, the impact force can be effectively prevented from being transmitted to boundary surfaces. Therefore, even if the impact force is repeatedly applied to the composite material, the boundary surfaces between the thermoplastic resin and the metal particles are not caused to collapse. The metal particles accordingly do not drop off from the composite material. More over, the thermoplastic resin and the metal particles can be bond by means of a coupling agent in the same as the bonding of the silica glass spheres and the thermoplastic resin. As the coupling agent, a silane coupling agent having an amide group, a silane coupling agent having an epoxy group, conventionally known coupling agents, or the like can be applied.

FIG. 2 explains an example of principles for improving mechanical strength of a composite material, which is produced at least by compounding metal particles in a thermoplastic resin. When the composite material incorporates silica glass spheres 11 and metal particles 12 therein in a volume ratio of 3:1, it is conceivable that the silica glass spheres Hand the metal particles 12 are oriented at a surface of the composite material in the same ratio. However, the ratio thereof in the composite material is not limited to the above. When an impact force being greater than a cohesive strength between the thermoplastic resin and the silica glass spheres 11 is repeatedly applied to this composite material, the silica glass spheres 11 positioned at the surface of the composite material may drop off. However, the metal particles 12, which can absorb the impact force, do not drop off and could remain as being. Therefore, even when an impact force is further applied to the composite material after the drop off of the silica glass spheres 11, the metal particles 12 can prevent the thermoplastic resin from being worn out, and further can prevent the composite material from further collapsing. As described above, by combining metal particles in a thermoplastic resin composite material, mechanical strength of the composite material can be effectively enhanced.

A compounding volume ratio of the metal particles in the thermoplastic resin composite material is not limited can be set at an arbitrary value. However, in terms of the compounding ratio described above, it is preferable that the composite material contains the metal particles at 30 vol. % or more relative to a total volume of the composite material. As a generality, a metal particle has a coefficient of linear expansion smaller than that of a generally used thermoplastic resin. The compounding of the metal particles in the thermoplastic resin accordingly controls the coefficient of linear expansion of the thermoplastic resin at a low level. Therefore, by controlling a volume ratio of the thermoplastic resin in the composite material, the composite material can result in having a smaller coefficient of linear expansion and higher mechanical strength as attributes thereof. For example, when the volume ratio of a thermoplastic resin in a thermoplastic resin composite material is set at 35 vol. %, a coefficient of linear expansion of the thermoplastic resin composite material can be effectively controlled at a low level even if metal particles occupy the rest of the volume of the composite material, which is 75 vol. %.

A type of metal particle to be applied is not limited and can be any metal particle as needed. As a preferable metal particle that easily absorb an impact force, gold, silver, copper, aluminum, or the like can be preferably applied. In terms of one of attributes of a metal particle such as handleability, manufacturing cost and a density that should be approximate to that of a silica glass sphere, it is preferable that aluminum is applied as the metal particle for this case.

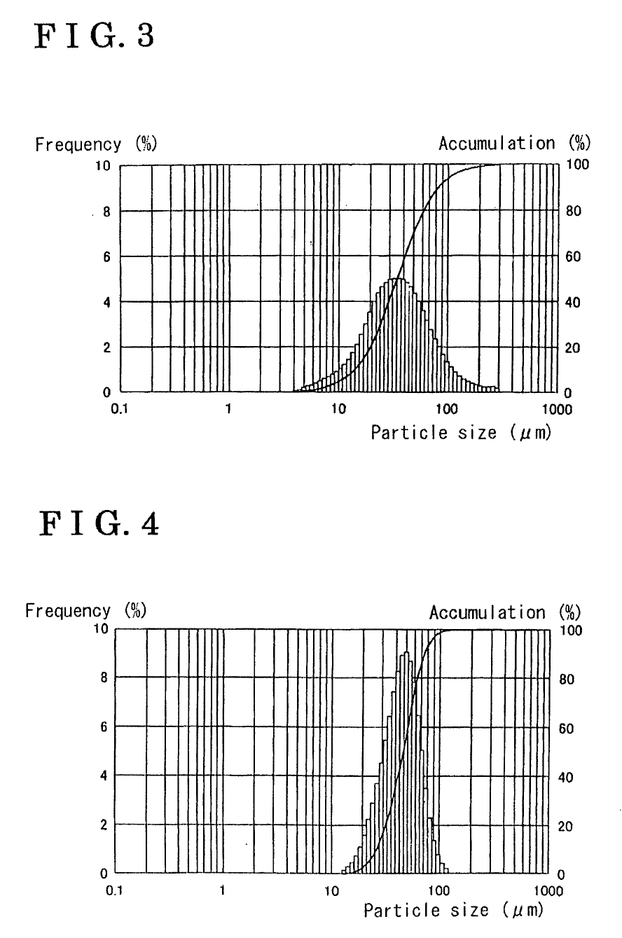

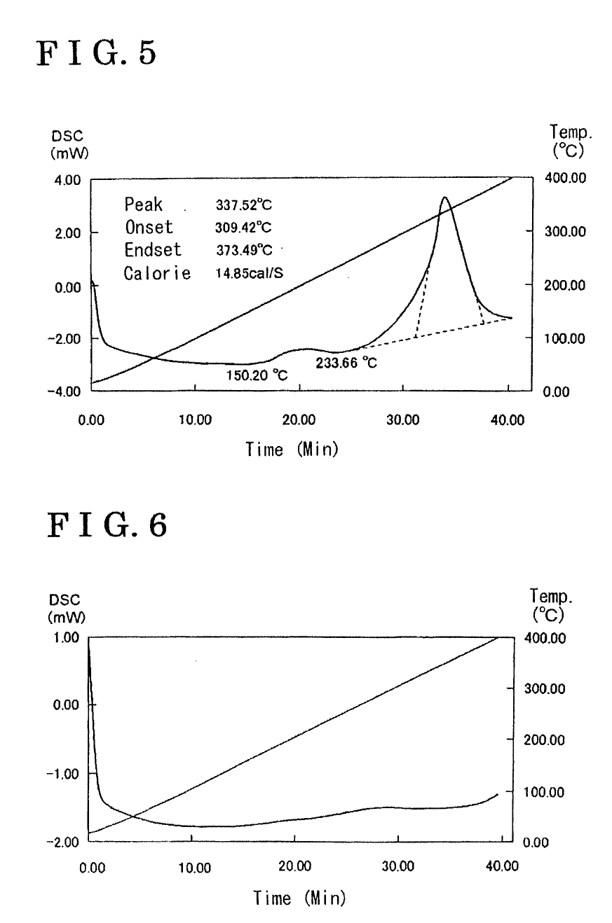

A particle size of metal particles to be combined in the composite material is not limited as well as the silica glass spheres, but can rather be decided on a basis of a type of product to be manufactured by use of the composite material. For example, when metal particles, of which a peak of frequency in terms of metal particle size distribution, is confined within a range of 20-60 μm, it becomes possible to control a bulk density of the metal particles at a low level. Therefore, the metal particles can be preferably combined in the composite material. Furthermore, when an aluminum particle is applied as a metal particle that can be combined in a thermoplastic resin composite material, it is also preferable that a particle size thereof is rather large to a certain extent. Even if small particle-size aluminum particles are included in the composite material, it could be possible that the small particle-size aluminum particles are preferably applied depending on a compounding volume ratio of a large particle-size aluminum and a silica glass sphere blended in the composite material, depending on a degree of mechanical strength which the composite material is expected to have, or the like. However, when aluminum particles respectively confined as illustrated in FIGS. 3 and 4 in terms of aluminum particle size distribution are applied with thermal analysis, the aluminum particles that have a particle size being less than 10 μm generate heat by an oxidation reaction therein around 230° C. This temperature actually corresponds to a temperature at which a composite material incorporating a thermoplastic resin and aluminum particles is fusion injection-molded. Therefore, concerning the composite material having the thermoplastic resin and the aluminum particles which have a particle size being less than 10 μm, a coupling agent, which has bond the thermoplastic resin and the aluminum particles, mixed in the composite material may evaporate through a process for extrusion molding the composite material. On occasions, a cohesive strength between the thermoplastic resin and the aluminum particles may be reduced. In this case, a combination of the aluminum particles in the composite material may deteriorate mechanical strength of the composite material. In light of the foregoing, it is preferable that the thermoplastic resin composite material comprises aluminum particles of which a particle size is 10 μm or more.

In the composite material having large particle size silica glass spheres of which the peak of frequency thereof is confined within a range of 20-60 μm, middle particle size silica glass spheres of which the peak of frequency thereof is confined within a range of 5-20 μm and small particle size silica glass spheres of which the peak of frequency thereof is confined within a range of 1-3 μm, when a mixture of silica glass spheres and aluminum particles is combined in a high compounding volume ratio in this thermoplastic resin composite material, it is preferable that a part of or all of the large particle size silica glass spheres be replaced by the aluminum particles of which the peak of frequency is substantially the same as the peak of frequency of the large particle-size glass spheres.

The thermoplastic resin composite material according to the embodiment of the present invention as described above can possess a coefficient of linear expansion of a thermoplastic resin at a low level than that of conventional thermoplastic resins, while of which attributes of the conventional thermoplastic resin can be maintained. Moreover, the thermoplastic resin composite material according to the embodiment of the present invention as described above can be achieved to have enhanced mechanical strength, while of which a coefficient of linear expansion can be controlled at a low level. Therefore, the composite material according to the embodiment of the present invention can be applied for more various uses than conventional ones. Hereinafter, following explanation will be given for describing a method of manufacturing the composite material according to the embodiment of the present invention. Further, applicable usages of the composite material are described as follows.

A thermoplastic resin which can be applied for the composite material according to the embodiment of the present invention can be manufactured by a conventional polymerizing method. The polymerized thermoplastic resin can be formed to be a pellet type having a length of 2-3 mm. A commercially available thermoplastic resin can be applied as usage.

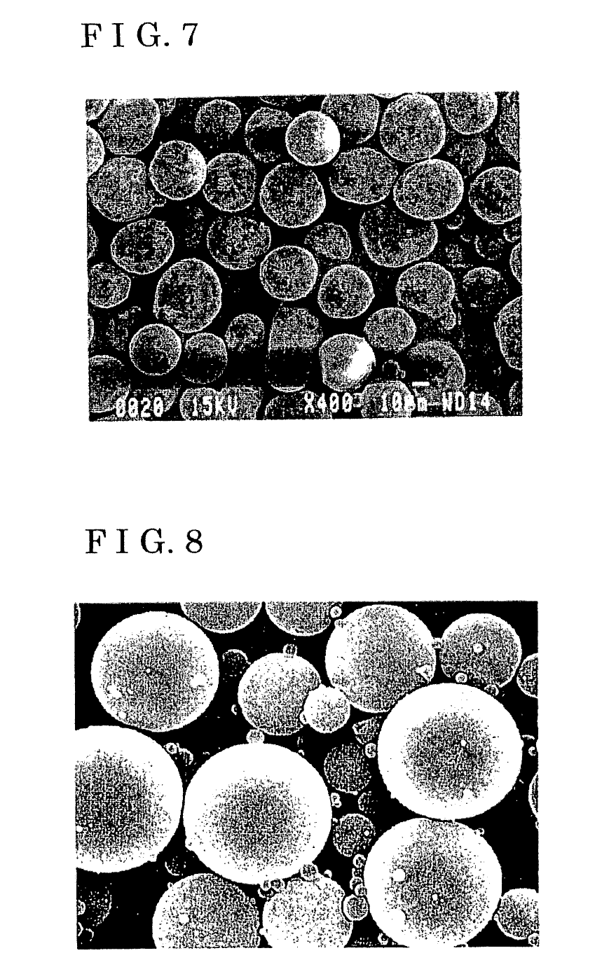

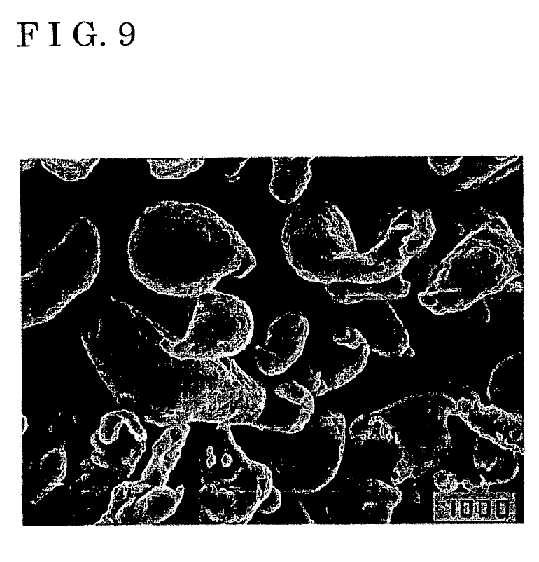

Silica glass spheres can be manufactured by a conventional arbitrary method, but it is preferable that the silica glass sphere is manufactured by a fusion method. In this case, a specific surface of the silica glass spheres can be preferably controlled at a relatively low level as illustrated in FIGS. 7 and 8. Therefore, the silica glass spheres can be combined in a high volume ratio relative to a volume of a thermoplastic resin, as described above. Moreover, a surface of the silica glass sphere particles can possess fine concaves and convexes, thereby enhancing a reaction of the silica glass sphere particles relative to a coupling agent. Moreover, when the fusion method for manufacturing the silica glass sphere particles is compared with another wet-type manufacturing process such as a sodium silicate method, the silica glass spheres can be manufactured at a lower manufacturing cost. The fusion method herein can be also referred to as a high-speed gas flame fusion method, by which the silica glass spheres are manufactured by melting raw material with a high purity for a silica glass in a combustion flame containing a mixture of LPG and oxygen gas, a mixture of hydrogen gas and oxygen gas, or the like. The molten silica glass is injected from a nozzle by a predetermined pressure level air, emitted into an air and is quenched. Through a quenching and solidifying process, the silica glass spheres can result in a powder of which a shape is substantially a sphere by means of a surface tension applied to a particle surface. According to this method, a particle size of the powder can be controlled in accordance with a nozzle diameter, an emitting pressure, a temperature upon emitting, or the like. The particle shape can be decided on a basis of a raw material for silica glass spheres such as natural silica (quartz), synthetic silica glass, or the like.

A coupling agent can be manufactured by a synthetic organic reaction depending on a thermoplastic resin to be applied. A commercially available composite material can be applied as a coupling agent. Moreover, an arbitrary functional group can be added to a commercially available composite material to be applied by a synthetic organic reaction.

A thermoplastic resin produced as described above is blended with a predetermined amount of silica glass spheres and a predetermined amount of coupling agents by a mixer. The mixture thereof is filled in an extrusion-molding machine. The respective amounts of the silica glass spheres and the coupling agents can be decided arbitrarily, but it would be preferable that the coupling agents be compounded in a volume ratio of 1-2 wt % relative to a volume of the silica glass spheres as filler. The composite material according to the embodiment of the present invention is obtained by extruding the thermoplastic resin, which has molten at a predetermined melting temperature, into an air. The molten thermoplastic resin being extruded outside can be consecutively cut to possess an approximately 2-3 mm in length. The composite material obtained as described above can be molded to form an arbitrary shape for usages by an injection molding.

As for the composite material, which has incorporated therein the thermoplastic resin, the silica glass spheres and the metal particles, in the aforementioned manufacturing method, the composite material can be preferably obtained by mixing the metal particles in the thermoplastic resin substantially in the same time as the silica glass spheres are mixed therein. In this case, it is preferable that the coupling agent be combined in 1-2 wt % relative to a total volume of the silica glass spheres and the metal particles. When aluminum particles are utilized as the metal particles, the aluminum particles can be preferably manufactured by means of a conventional atomizing method. In the atomizing method, it becomes possible that the obtained aluminum particles result in having different but sphere shapes, as illustrated in FIG. 9.

A compounding volume ratio of silica glass spheres or of a mixture of silica glass spheres and metal particles in a thermoplastic resin composite material can be decided arbitrarily. However, the compounding volume ratio can be decided on a basis of a coefficient of linear expansion of the composite material, which is considered as a target value at a singular point such as a glass transmission point of the thermoplastic resin. For example, when the composite material according to the embodiment of the present invention is applied within a wide temperature range in the vicinity of a material (e.g. metal material) of which a coefficient of linear expansion is smaller than that of the composite material, the compounding volume ratio of silica glass spheres or of the mixture of silica glass spheres and metal particles can be decided so as to substantially match a coefficient of linear expansion of the composite material at a singular point which becomes an intermediate point within the wide temperature range with a coefficient of linear expansion of a material, of which a coefficient of linear expansion is smaller than that of the composite material, at a singular point. In this case, at wherever the composite material has been utilized within the wide temperature range, a difference between the coefficient of linear expansion of the composite material and that of the material positioned in the vicinity of the composite material can be controlled at a relatively low level.

The composite material according to the embodiment of the present invention can be applied for various usages. In particular, when a thermoplastic resin and a metal material of which a coefficient of linear expansion is smaller than that of the thermoplastic resin are positioned with a small clearance therebetween, and are utilized within the wide temperature range, the attributes of the composite material according to the embodiment of the present invention can be exerted. Further, when two or more thermoplastic resins, of which coefficients of linear expansions are different, are positioned with a small clearance therebetween, and are utilized within the wide temperature range, the attributes of the composite material according to the embodiment of the present invention can be exerted. That is, in the composite material according to the embodiment of the present invention, a coefficient of linear expansion thereof, which varies in response to a temperature, can be effectively controlled. Even when other material is positioned in the vicinity of the composite material according to the embodiment of the present invention, a mutual interference as a result of a thermal expansion of the materials can be effectively prevented.

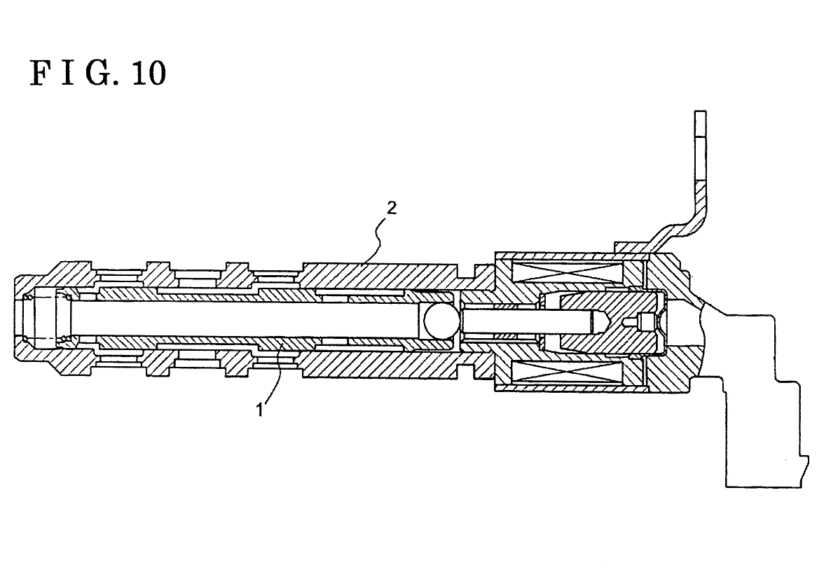

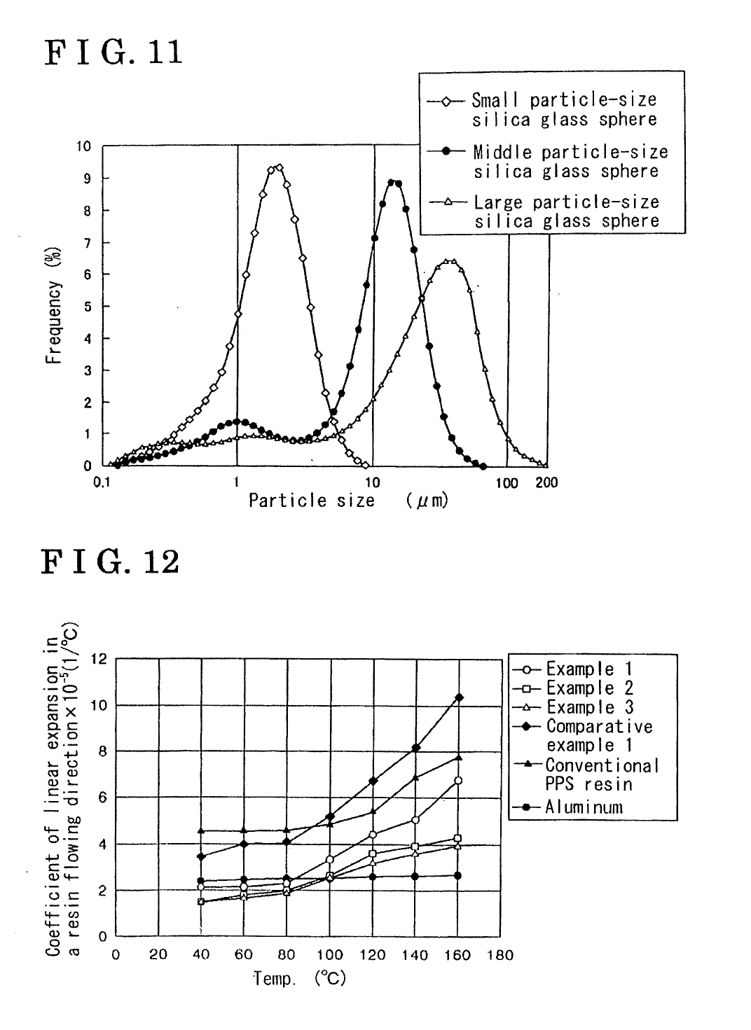

The composite material according to the embodiment of the present invention can be applied as a valve 1 of a solenoid valve as illustrated in FIG. 10. That is, the solenoid valve is configured with the valve 1 made of the composite material according to the embodiment of the present invention and a sleeve 2 made of aluminum. The other structure of the solenoid valve with the composite material according to the embodiment of the present invention is substantially the same as that of conventional solenoid valves.

As a generality, it is preferable that a clearance between a valve and a sleeve be as small as possible so as to seal the clearance with an oil viscosity, thereby enabling to reduce an amount of oil which may leak through the clearance. For example, the clearance can be maintained approximately at 20 μm. However, a generally used thermoplastic resin has a large coefficient of linear expansion. Further, a difference between the coefficient of linear expansion of the thermoplastic resin in the resin flowing direction and the coefficient of linear expansion of the thermoplastic resin in a direction at right angles to the resin flowing direction may be large. Therefore, when the thermoplastic resin is applied as the valve 1, the valve expands even when the solenoid valve operates within the operating temperature range. In this case, on occasions, the valve 1 may impact with the sleeve 2.

In particular, the thermoplastic resin has a glass transition point, which is one of the attributes being characteristic to a resin. When the operating temperature reaches a temperature range that exceeds the glass transition point, polymers of the thermoplastic resin transits from a one-dimensional translational movement to a three-dimensional movement. That is, around the glass transition point, the coefficient of linear expansion of the thermoplastic resin increases. The more the operating temperature goes away from the glass transition point, the greater the coefficient of linear expansion thereof becomes. In terms of the attribute of the thermoplastic resin, it is important to consider an amount of the coefficient of linear expansion thereof when a component made of a thermoplastic resin can not be helped being used at a temperature beyond the glass transition point of the thermoplastic resin.

Moreover, a thermoplastic resin has another good attribute by which the thermoplastic resin can be molded to have various types of shapes by means of an injection molding method. However, the coefficient of linear expansion of the thermoplastic resin widely varies depending on injected directions. A coefficient of linear expansion of a thermoplastic resin in an injected direction is smaller in comparison with that thereof in a direction at right angles to the injected direction. In the event that the thermoplastic resin with such attribute is applied as a valve for a solenoid valve, the following problems may occur regarding a thermal expansion of the thermoplastic resin. That is, a thickness direction (an up and down direction) of the valve 1 (illustrated in FIG. 10), which determines the clearance between the valve 1 and the sleeve 2, corresponds to the direction at right angles to the injected direction of the molten resin. The clearance between the valve 1 and the sleeve 2 is decided on a basis of the coefficient of linear expansion in the direction at right angles to the injected direction of the thermoplastic resin forming the valve 1. For example, when the solenoid valve with the valve 1 made of the thermoplastic resin is applied at an oil pressure passage control of a vehicle transmission, the solenoid valve is on occasions used at a temperature around 150° C. The temperature around 150° C. exceeds the glass transition point of a generally used thermoplastic resin by 50° C. or more. In light of the foregoing, when the valve 1 of the solenoid valve is manufactured not with a thermoplastic resin but with a synthetic resin, a thermal expansion ratio of the synthetic resin in response to a temperature should be highly considered.

On the other hand, a thermoplastic resin has a sufficiently good moldability to form an arbitrary shape. By making the best use of this good attribute of the thermoplastic resin, a machine work, which has been conventionally required for manufacturing a valve, is not needed, and the valve can be manufactured at a lower cost. As described above, recent requirements have led to a thermoplastic resin to be applied for a valve of a solenoid valve.

In light of the foregoing, by applying the composite material according to the embodiment of the present invention to'the valve 1, the valve 1 can be molded to form an arbitrary shape, while a coefficient of linear expansion of the valve 1 can be controlled to be substantially the same as that of an aluminum forming the sleeve 2. Therefore, even when the clearance between the valve 1 and the sleeve 2 is approximately 20 μm, mutual interference therebetween can be prevented in favor of the clearance which can be maintained as being. When the coefficient of linear expansion of the composite material according to the embodiment of the present invention is controlled, it is preferable that the coefficient of the linear expansion of the composite material be controlled at a value substantially the same as a coefficient of linear expansion of aluminum in the same manner as when the valve 1 and the sleeve 2 are manufactured with an identical material. Moreover, since the solenoid valve having the composite material according to the embodiment of the present invention is operated within a wide temperature range, it is preferable that the coefficient of linear expansion of the composite material is set on a basis of the coefficient of linear expansion of the aluminum at a substantially intermediate temperature within the temperature range, e.g., the coefficient of linear expansion of the aluminum at a glass transition point of the thermoplastic resin. In this case, even when the operating temperature shifts to a lower temperature or a higher temperature, a deviance between the coefficient of linear expansion of the aluminum and the coefficient of linear expansion of the composite material can be restrained at a minimum amount.

On the other hand, a conventional solenoid valve has been known, in which a tip end of the valve 1 comes in contact with a plunger portion made of a stainless steel through a valve operation. The valve operation is repeated about several millions times until the solenoid valve comes to the end of its life. Therefore, it is natural that the valve 1 is required to have a high mechanical strength. In light of the foregoing, it is preferable that the valve 1 be manufactured with the composite material according to the embodiment of the present invention, which contains incorporated therein a mixture of silica glass spheres and metal particles blended in a thermoplastic resin.

TABLE 1

| | Tensile strength | Proof stress | Elongation | Specific |
|---|---|---|---|---|
| | (N/mm²) | (N/mm²) | rate (%) | gravity |
| A | 90 | 35 | 35 | 2.71 |
| B | 130 | 120 | 8 | 2.71 |
| C | 130 | 100 | 20 | 2.71 |
| D | 200 | 180 | 6 | 2.71 |
| E | 110 | 40 | 30 | 2.73 |
| F | 220 | 195 | 5 | 2.73 |

When aluminum particles are applied as metal particles, it is possible that the thermoplastic resin can be blended with aluminum particles with various types of attributes as summarized in table 1. In this case, metal particles which can be applied can be decided on basis of an impact force to be applied to the composite material. As a generality, an impact force to be applied to the tip end of the valve 1 by the plunger component is around 28.4 N/mm2 per one time. In terms of the impact force, the aluminum particles of which a proof stress is greater than 28.4N/mm2 is preferably applied. The aluminum particles containing an attribute A or E, in which the elongation rate is relatively large, can be preferably applied since such aluminum particles can receive the impact force by an elastically deformed area thereof. In terms of an attribute of being easily mixed, a cost per volume, and the like, the aluminum particles containing the attribute A, in which the specific gravity is relatively small, can be preferably applied. As aluminum particles having such attribute, JIS alloy no. 1100-O series is preferably applicable.

The followings will explain examples of the composite material according to the embodiment of the present invention. As a thermoplastic resin as a matrix of the composite material, a polyphenylene sulfide (PPS) resin can be applied, which is versatile being superior in heat resistance, moldability, chemical stability and mechanical strength. The composite material is manufactured by compounding a mixture of silica glass spheres and coupling agents in the PPS resin, and a coefficient of linear expansion of the composite material is measured. The measuring of the coefficient of linear expansion was carried pursuant to ISO11359-2.

### EXAMPLE 1

A mixture of small particle-size silica glass spheres of which a peak of frequency in terms of particle size distribution is confined at 2 μm, middle particle-size silica glass spheres of which a peak of frequency is confined at 14 μm and large particle-size silica glass spheres of which a peak of frequency is confined at 37 μm is blended in 56 vol. % in a PPS resin of pellet shaped, of which specific gravity is 1.36 and fusion viscosity is approximately 600 poise at a temperature of 315° C. A coupling agent of which molecular structure is (CH₂OH)CH₂OC₃H₆Si(OCH₃)₃ is added in 1.5 wt % relative to the silica glass spheres. The PPS resin, the silica glass spheres and the coupling agent are agitated by a mixer for 5 minutes. The above mixture is then filled in a twin spindle type injection molding machine and injection molded at approximately 315° C., thereby obtaining the composite material according to the embodiment of the present invention. When the coefficient of linear expansion of the composite material in a resin flowing direction is measured at each temperature, the coefficient of linear expansion thereof is smaller than that of a conventional PPS resin, as explained in FIG. 12. Regarding a specific surface area of the silica glass spheres mixed in the composite material, the specific surface area of the large particle-size silica glass spheres is 7.02 m²/g, the specific surface area of the middle particle-size silica glass spheres is 2.57 m²/g and the specific surface area of the small particle-size silica glass spheres is 2.65 m²/g. The density of each of the large, middle and small particle-size silica glass spheres is 2.15 g/cm³.

### EXAMPLES 2 AND 3

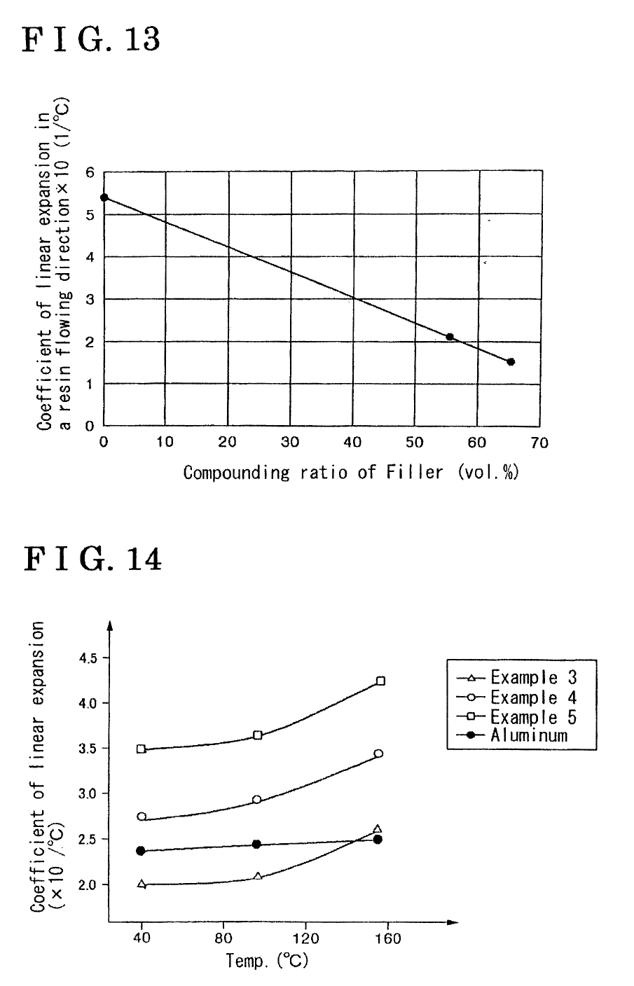

The composite materials according to examples 2 and 3 are respectively different from the composite material according to the example 1 in terms of amounts of silica glass spheres and coupling agents. According to the example 2, a mixture of silica glass spheres in 62.4 vol. % and coupling agents in 1.5 wt % relative to the amount of the silica glass spheres is blended in the PPS resin. According to the example 3, a mixture of silica glass spheres in 64.8 vol. % and coupling agents in 1.5 wt % relative to the amount of the silica glass spheres is blended in the PPS resin. When coefficients of linear expansions of both composite materials in the resin flowing directions according to the examples 2 and 3 are measured at each temperature in the same manner as the example 1, the coefficient of linear expansion is reduced in response to an increase of a compounding ratio of the silica glass spheres, as explained in FIG. 12. The coefficients of linear expansion according to the examples 2 and 3 are approximated to the coefficient of linear expansion of the aluminum forming the sleeve 2 illustrated in FIG. 10. In terms of a relationship between a coefficient of linear expansion of silica glass spheres and a compounding ratio thereof, FIG. 13 in detail explains the relationship as a Rule of Mixture (ROM) relevant to the coefficient of linear expansion of the composite material in accordance with a formula: N=n₁·V₁+n₂·V₂(N: coefficient of linear expansion of the composite material, n₁: coefficient of thermal expansion of silica glass spheres, n₂: coefficient of linear expansion of a thermoplastic resin, V₁: compounding ratio of silica glass spheres in volume and V₂: compounding ratio of thermoplastic resin in volume). Therefore, it becomes possible to obtain easily a compounding ratio of silica glass spheres in order to achieve a coefficient of linear expansion of the composite material for usages.

### COMPARATIVE EXAMPLE 1

As a comparative example, a composite material is manufactured, in which conventional glass fibers are mixed in 40 wt % (substantially corresponding to 27 vol. %) in the PPS resin that is applied for the examples of the present invention. A coefficient of linear expansion of the composite material in a resin flowing direction is measured at each temperature in the same manner as the examples. FIG. 12 in detail explains that the coefficient of linear expansion of the comparative example is larger than that of the composite material according to the embodiment of the present invention.

### EXAMPLES 4 AND 5

The composite materials according to examples 4 and 5 are respectively different from the composite material according to the example 1 in terms of the amounts of silica glass spheres and coupling agents contained therein and in terms of that the composite materials according to examples 4 and 5 contain aluminum particles. As aluminum particles, according to the example 4, JIS alloy no. 1100-O series material having the attribute A in table 1 is applied. These aluminum particles are considered to have a particle size distribution explained in FIG. 4. According to the example 4, a mixture of silica glass spheres in 32.5 vol. %, aluminum particles in 32.5 vol. % and coupling agents in 1.5 wt % relative to the total amount of the silica glass spheres and the aluminum particles is blended in the PPS resin, thereby obtaining the composite material. According to the example 5, a mixture of aluminum particles in 65 vol. % and coupling agents in 1.5 wt % relative to the total amount of the aluminum particles is blended in the PPS resin, thereby obtaining the composite material. When coefficients of linear expansions of both composite materials in the resin flowing directions according to the examples 4 and 5 are measured at each temperature in the same manner as the example 1, the coefficient of linear expansion is controlled at a low level even if the composite materials contain the aluminum particles, as explained in FIG. 14.

### EXAMPLE 6

The valve 1 of the solenoid valve illustrated in FIG. 10 is manufactured by use of the composite material obtained according to the example 3. That is, the composite material according to the example 3 is cut to form a pellet shape with 2-3 mm in length and is filled in an injection molding machine. The composite material is injection-molded at a molding temperature of 315° C., an injection molding pressure of 1000 kgf/cm² and an injection molding speed of 1 m/s. The composite material then results in the valve 1 of which major diameter is 10.75 mm. The valve 1 is disposed in the sleeve 2 of which inner diameter is 10.79 mm with a clearance relative to the sleeve 2. When a coefficient of linear expansion of the valve 1 is measured at arbitrary points A, B and C along a direction at right angles to a resin flowing direction at each temperature, the coefficient of linear expansion of the valve 1 becomes smaller totally as illustrated in table 2. Further, even if the operating temperature is increased up to 150° C., an increase of the coefficient of linear expansion is controlled at a low level. Moreover, even if aluminum, of which coefficient of linear expansion is 2.3×10⁻⁵/° C. at a temperature of 150° C., is applied for the sleeve 2, a difference between the coefficient of linear expansion of the valve 1 and that of the sleeve 2 is controlled at a low amount at the temperature of 150° C. Therefore, even if the solenoid valve with the valve 1 made of the composite material according to the embodiment of the present invention is operated under a high-temperature ambient, it becomes possible to prevent a mutual interference between the valve 1 and the sleeve 2.

TABLE 2
Coefficient of linear expansion
in a direction at right angles to an injection direction (×10⁻⁵/° C.)

| | Example 4 | | | Comparative Example 2 | | |
|---|---|---|---|---|---|---|
| Temp. Change | A | B | C | A | B | C |
| Normal temp. − 50° C. | 1.982 | 2.378 | 1.887 | 2.942 | 2.733 | 2.982 |
| Normal temp. − 80° C. | 1.920 | 2.344 | 1.885 | 3.193 | 3.219 | 3.085 |
| Normal temp. − 100° C. | 2.024 | 2.385 | 1.988 | 3.313 | 3.353 | 3.154 |
| Normal temp. − 120° C. | 2.230 | 2.450 | 2.201 | 3.668 | 3934 | 3.578 |
| Normal temp. − 150° C. | 2.557 | 2.710 | 2.599 | 4.112 | 4.349 | 4.043 |

### COMPARATIVE EXAMPLE 2

As another comparative example, a valve is manufactured with a conventional PPS resin, and a coefficient of linear expansion of the valve is measured at the arbitrary points A, B and C in the same manner as the example 3. The coefficient of linear expansion of the valve according to the comparative example 2 was greater in comparison with that of the composite material according to the example 6. Moreover, the coefficient of linear expansion according to the comparative example 2 was increased in response to an increase of the temperature. When the sleeve 2 was assumed to have been manufactured with aluminum, the coefficient of linear expansion of the valve 1 at a temperature of 150° C. became about twice as large as that of the sleeve 2. Therefore, when the valve 1 and the sleeve 2 are used under a high-temperature atmosphere, a total of dimensional change of the valve 1 and the sleeve 2 becomes larger than a clearance therebetween. Therefore, on occasions, the valve 1 and the sleeve 2 may interfere mutually.

### EXAMPLES 7 AND 8

A valve 1 of which major diameter is 10.75 mm is manufactured with each composite material according to each example 4 and 5 in the same manner as the example 6. Variation of a clearance between an outer surface of the valve 1 and the sleeve 2 of which inner diameter is 10.79 mm is measured in the same manner as the valve 1 according to the example 6. Table 3 summarizes that the valve 1 and the sleeve 2 do not mutually interfere within a temperature range of 40-150° C., and a clearance therebetween still remains within the temperature range.

TABLE 3

| | Clearance Change (μm) | | |
|---|---|---|---|
| | 40° C. | 95° C. | 150° C. |
| Example 6 | +0.40 | +1.49 | +2.21 |
| Example 7 | −0.41 | −1.54 | −3.11 |
| Example 8 | −1.22 | −4.56 | −8.50 |

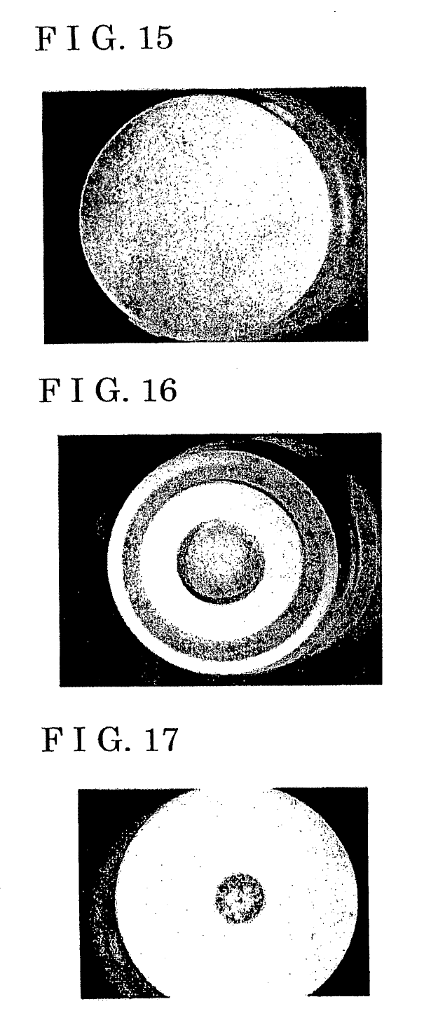

Further, a valve operation experiment was carried millions times by use of the solenoid valve according to the examples 6 and 7. The tip end of the valve 1 of each solenoid valve according to each example 6 and 7 has not been applied with any damage prior to the experiment, as illustrated in FIG. 15. After the experiment, the tip end of the valve 1, which is opposed to the plunger component has been worn out following the shape of the plunger component as illustrated in FIG. 16. On the other hand, in the valve 1 according to the example 7, slight traces remain at the tip end of the valve 1. That is, by combining aluminum particles in the thermoplastic resin, remarkable improvement in mechanical strength of the composite material can be confirmed.

As described above, the composite material according to the embodiment of the present invention can be applied not only for usages, for which conventional resins have been applied, but also for other usages, for which conventional resins having a high coefficient of linear expansion could not be applied, such as a valve of a solenoid valve.

The principles, the preferred embodiment and mode of operation of the present invention have been described in the foregoing specification. However, the invention, which is intended to be protected, is not to be construed as limited to the particular embodiment disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A composite material comprising:
a thermoplastic resin; and
silica glass spheres having a specific surface area of 0.5-10 m²/g,
wherein the composite material incorporates the silica glass spheres in an amount of 40% by volume or more.

2. A composite material comprising:
A thermoplastic resin; and
silica glass spheres mixed with plural types of silica glass spheres of which peaks of frequency in terms of particle size distribution are different.

3. A composite material according to claim 2, wherein the silica glass spheres are mixed with at least the three types of silica glass spheres: large particle-size silica glass spheres of which a peak of frequency in terms of particle size distribution is confined within a range of 20-60 μm, middle particle-size silica glass spheres of which a peak of frequency in terms of particle size distribution is confined within a range of 5-20 μm and small particle-size silica glass spheres of which a peak of frequency in terms of particle size distribution is confined within a range of 1-3 μm.

4. A composite material according to claim 3, wherein a total volume of the large particle-size silica glass spheres and the middle particle-size silica glass spheres occupies an amount of 70% by volume or more relative to an entire volume of the silica glass spheres.

5. A composite material according to claim 1, further comprising: metal particles.

6. A composite material according to claim 5, wherein the composite material incorporates the metal particles in an amount of 30% by volume or more.

7. A composite material according to claim 5, wherein the metal particles are aluminum particles of which a peak of frequency in terms of particle size distribution is confined within 20-60 μm.

8. A method of manufacturing a composite material incorporating a thermoplastic resin and silica glass spheres manufactures the composite material which incorporates the silica glass spheres at a compounding ratio determined on a basis of a coefficient of linear expansion of the composite material at a singular point of the thermoplastic resin.

9. A method of manufacturing the composite material according to claim 8, wherein the singular point is a glass transition point of the thermoplastic resin when the composite material is utilized in the vicinity of a material having a coefficient of linear expansion being smaller than a coefficient of linear expansion of the composite material, and the composite material includes the silica glass spheres at a compounding ratio for mating the coefficient of linear expansion of the composite material at the glass transition point with the coefficient of linear expansion of the material.

10. A method of manufacturing a composite material incorporating a thermoplastic resin, silica glass spheres and metal particles manufactures the composite material which is combined with the silica glass spheres and the metal particles at a compounding ratio for matching a coefficient of linear expansion of the composite material at a glass transition point of the thermoplastic resin with a coefficient of linear expansion of a material, which is smaller than the coefficient of linear expansion of the composite material, at the glass transition point when the composite material is utilized in the vicinity of the material.
